(19) United States
(12) Patent Application Publication
(10) Pub. No.: US 2024/0219902 A1
(43) Pub. Date: Jul. 4, 2024

(54) PROTOCOL AND USER-INTERFACE FOR REVERSING AN AUTONOMOUS VEHICLE UNDER REMOTE ASSISTANCE SUPERVISION

(71) Applicant: GM Cruise Holdings LLC, San Francisco, CA (US)

(72) Inventors: Spyros Maniatopoulos, San Francisco, CA (US); Andrey Kasaurov, Sunnyvale, CA (US); Dmitry Bragin, San Francisco, CA (US); Soleil Phan, San Francisco, CA (US)

(73) Assignee: GM Cruise Holdings LLC, San Francisco, CA (US)

(21) Appl. No.: 18/149,779

(22) Filed: Jan. 4, 2023

(51) Int. Cl. G05D 1/00; G05D 1/02

(52) U.S. Cl. CPC G05D 1/0016; G05D 1/0038; G05D 1/0077; G05D 1/0214; G05D 2201/0213

(57) ABSTRACT

Examples of the present disclosure provide a computer-implemented system, comprising: one or more non-transitory computer-readable media storing instructions, which when executed by one or more processing units, cause the one or more processing units to perform operations including: providing instructions to shift a gear of a vehicle from drive to reverse; receiving, from the vehicle, an end-pose and a reversing path for the vehicle; calculating a reverse maneuver for the vehicle to move in reverse gear based on the end-pose and the reversing path; transmitting, to the vehicle, signals to move the vehicle in reverse gear, the signals being transmitted at a signal rate above a predetermined rate threshold; and stopping the vehicle in response to reaching the end-pose.

### BACKGROUND

### 1. Technical Field

The present disclosure generally relates to Autonomous Vehicles (AVs) and, more specifically, a system and a method for facilitating a protocol and user-interface for reversing an AV under remote assistance supervision.

### 2. Introduction

An AV, also known as a self-driving car, driverless vehicle, and robotic vehicle, is a motorized vehicle that can navigate without a human driver. AVs use multiple sensors to sense the environment and move without human input. Sensors in an exemplary AV can include camera sensors, light detection and ranging (LIDAR) sensors, and radio detection and ranging (RADAR) sensors, among others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. Typically, the sensors are mounted at fixed locations on the AVs. The automation technology in the AVs may also enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating the vehicles in making driving decisions. The AV can be used to pick up passengers and drive the passengers to selected destinations. The AV can also be used to pick up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. To facilitate this description, like reference numerals designate like structural elements. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a simplified block diagram of an example computer-implemented system including a user-interface for reversing an AV under remote assistance supervision, according to some examples of the present disclosure;

FIG. 1B illustrates a simplified block diagram of a portion of the user-interface of FIG. 1A, according to some examples of the present disclosure;

FIG. 1C illustrates a simplified block diagram of another portion of the user-interface of FIG. 1A, according to some examples of the present disclosure;

FIG. 2 illustrates a simplified flow diagram representing operations in an example protocol for reversing an AV under remote assistance supervision, according to some examples of the present disclosure;

FIG. 3 illustrates a simplified block diagram of a computer-implemented system for reversing an AV under remote assistance supervision, according to some examples of the present disclosure;

FIGS. 4A and 4B are simplified flow diagrams representing operations in an example protocol for reversing an AV under remote assistance supervision, according to some examples of the present disclosure;

FIG. 5 illustrates a simplified flow diagram representing operations in another example protocol for reversing an AV under remote assistance supervision, according to some examples of the present disclosure;

FIG. 6 illustrates an example system environment that can be used to facilitate AV dispatch and operations, according to some aspects of the disclosed technology; and

FIG. 7 is a simplified block diagram illustrating various components associated with a computer-implemented system for reversing an AV under remote assistance supervision, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

AVs can provide many benefits. For instance, AVs may have the potential to transform urban living by offering opportunities for efficient, accessible, and affordable transportation. An AV may be equipped with various sensors to sense an environment surrounding the AV and collect information (e.g., sensor data) to assist the AV in making driving decisions. To that end, the collected information or sensor data may be processed and analyzed to determine a perception of the AV's surroundings, extract information related to navigation, and predict future motions of the AV and/or other traveling agents in the AV's vicinity. The predictions may be used to plan a path for the AV (e.g., from a starting position to a destination). As part of planning, the AV may access map information and localize itself based on location information (e.g., from location sensors) and the map information. Subsequently, instructions can be sent to a controller to control the AV (e.g., for steering, accelerating, decelerating, braking, etc.) according to the planned path.

The operations of perception, prediction, planning, and control at an AV may be implemented using a combination of hardware and software components. For instance, an AV stack or AV compute process performing the perception, prediction, planning, and control may be implemented as software code or firmware code. The AV stack or AV compute process may be executed on processor(s) (e.g., general processors, central processors (CPUs), graphical processors (GPUs), digital signal processors (DSPs), ASIC, etc.) and/or any other hardware processing components on the AV. Additionally, the AV stack or AV compute process may communicate with various hardware components (e.g., on-board sensors and control system of the AV) and/or with an AV infrastructure over a network.

AVs are, by definition, driverless in most situations. However, there are situations where it is desirable to have a human assist the AV in certain maneuvers. In other words, the level of confidence in the autonomous operation of the AV may be below a certain acceptable threshold under certain conditions. An example is a reverse maneuver that may be difficult for the AV to perform due to inherent sensory limitations (e.g., the AV may be able to identify some type of blockage on the road but may be unsure exactly what is causing the blockage or how to proceed; the AV's rear field of view, based on aggregated sensor data, may not be as extensive as the forward field of view; etc.), but which may be easily performed with direct or indirect remote human assistance. In some examples, different confusing factors such as operating environment, network communication, road conditions, weather conditions, etc. may indicate a low level of confidence in the autonomous operation of the AV, and it may be desirable for the AV to request remote assistance, for example, to determine a way out of the confusing factors, or to reorient itself, etc.

Accordingly, examples of the present disclosure disclose various software modules operating in conjunction with computer hardware and the AV to perform various operations for executing a reverse maneuver using remote instructions. The operations include providing instructions to shift a gear of the AV from drive (or park) to reverse; receiving, from the AV, an end-pose and a reversing path for the AV; calculating a reverse maneuver for the AV to move in reverse gear based on the end-pose and the reversing path; transmitting, to the AV, signals to move the AV in reverse gear, the signals being transmitted at a signal rate above a predetermined rate threshold; and stopping the AV in response to reaching the end-pose.

In another aspect of the present disclosure, instructions are generated to initiate a workflow in response to a first button on a user-interface transitioning from an unselected state to a selected state, the workflow being configured to enable an AV to reverse from an initial pose to a target pose. A visual representation of a path of the AV from the first pose to the target pose is generated. A state of a second button on the user-interface is monitored such that the workflow is terminated in response to the state of the second button changing from a selected state to an unselected state after a predetermined duration. Instructions are generated to move the AV along the path by a distance as calculated according to a movement of a slider on the user-interface, the instructions to move the AV being generated as long as the second button is in the selected state.

In yet another aspect of the present disclosure, a user-interface is provided for assisting a user to remotely maneuver the AV. The user interface may include: a first region configured to show a location of a vehicle and surrounding features; a second region configured to show one or more selectable options and one or more instructions; a third region configured to show a view from a camera of the vehicle; and a fourth region having a first selectable button and a second selectable button. Selecting the first selectable button triggers a workflow configured to move the vehicle in reverse gear along a selected path, holding the first selectable button in a selected state maintains execution of the workflow, releasing the first selectable button temporarily pauses the workflow, such that the vehicle stops moving in reverse gear along the selected path, and selecting the second selectable button terminates the workflow. Such features may enable remotely controlling the reverse maneuver of the AV in a safe and efficient manner.

In the drawings, same reference numerals refer to the same or analogous elements/materials shown so that, unless stated otherwise, explanations of an element/material with a given reference numeral provided in context of one of the drawings are applicable to other drawings where element/materials with the same reference numerals may be illustrated. Further, the singular and plural forms of the labels may be used with reference numerals to denote a single one and multiple ones respectively of the same or analogous type, species, or class of element.

Furthermore, in the drawings, some schematic illustrations of example structures of various devices and assemblies described herein may be shown with precise right angles and straight lines, but it is to be understood that such schematic illustrations may not reflect real-life manufacturing limitations which may cause the features to not look so “ideal” when any of the structures described herein are examined minutely. Note that in the figures, various components are shown as aligned merely for ease of illustration; in actuality, some or all of them may be misaligned. Further, the figures are intended to show relative arrangements of the components within their assemblies, and, in general, such assemblies may include other components that are not illustrated (e.g., various other components related to electrical functionality, or thermal mitigation). For example, in some further examples, the assembly as shown in the figures may include more electrical or thermomechanical components. Additionally, although some components of the assemblies are illustrated in the figures as being planar rectangles or formed of rectangular solids, this is simply for ease of illustration, and examples of these assemblies may be curved, rounded, or otherwise irregularly shaped as dictated by and sometimes inevitable due to the manufacturing processes used to make various components.

For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 112a-112e), such a collection may be referred to herein without the letters (e.g., as “112”).

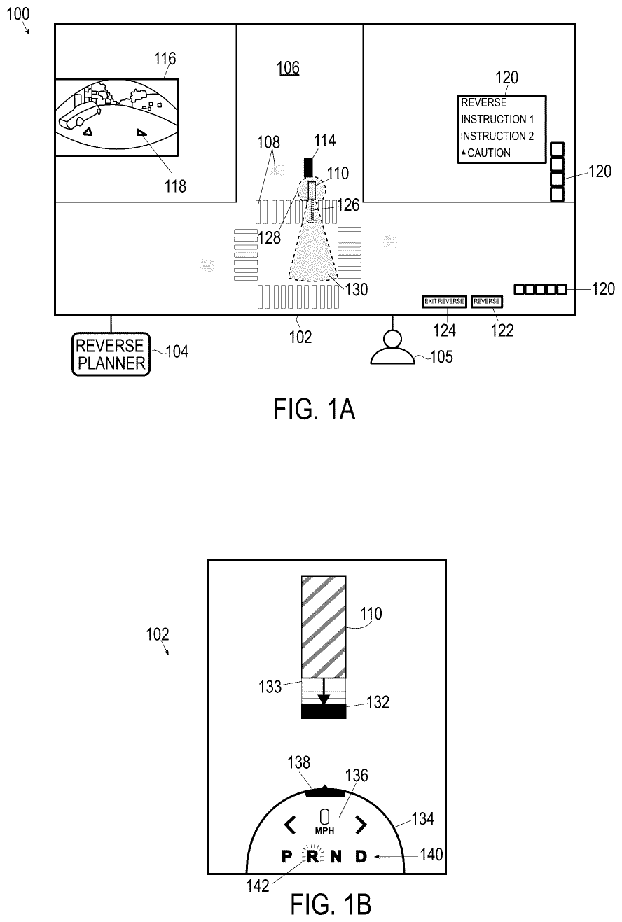

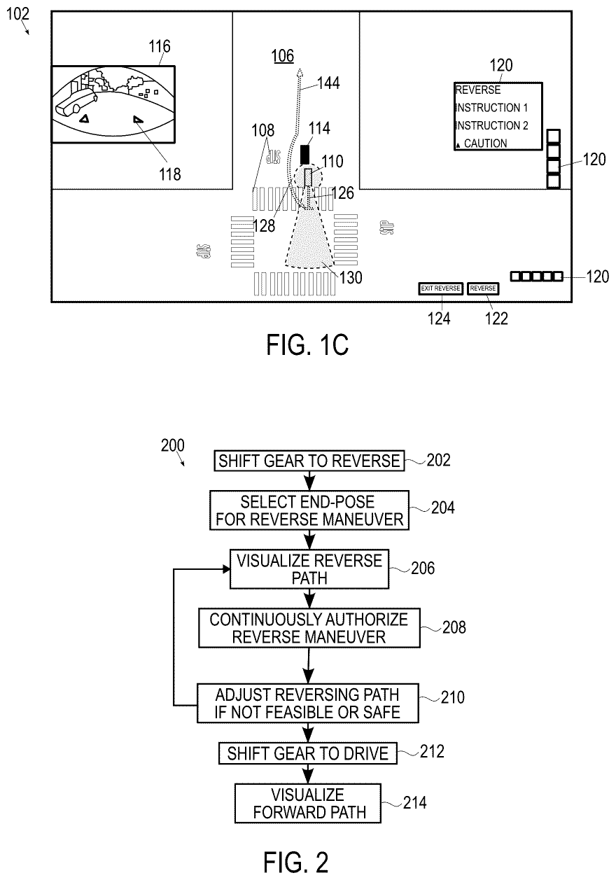

FIG. 1 illustrates a simplified block diagram of an example computer-implemented system 100 for facilitating a protocol and user-interface for reversing an AV under remote assistance supervision according to an example of the present disclosure. Computer-implemented system 100 may comprise at least a user-interface 102 and a reverse planner 104. In some examples, user-interface 102 may be part of a remote assistance platform configured to provide instructions to the AV from a remote location (i.e., from a location remote relative to the AV) and reverse planner 104 may be part of the AV. In other examples, both user-interface 102 and reverse planner 104 may be part of the remote assistance platform separate from the AV. A user 105 (e.g., human user, also called “adviser”) may interact with user-interface 102 suitably to facilitate generating instructions for the AV.

User-interface 102 comprises a region 106 configured to show a birds-eye-view of features 108 at a specific (e.g., selected) location. The visualization in region 106 may comprise a representation of the environment as obtained from a stream of sensory data. The specific location may comprise a road (e.g., crossroad as shown in the figure, or any other type of road configuration), or parking lot or other location. Features 108 may comprise, by way of examples, and not as limitations, markings on the asphalt, bystanders, trees, buildings, and other such visually observable objects around an AV 110. The visualization in region 106 may be stitched together from a variety of sources, including satellite data, sensors of AV 110, sensory data from AV 110 superimposed on map data of the location, etc. and provided in substantially real-time on user-interface 102. Any suitable source may be accessed to obtain visualization of features 108 within the broad scope of the disclosure herein. In the visualization shown in the figure, a blockage 114 preventing AV 110 from moving forward is present in front of AV 110. Blockages 114 may be present at the back of AV 110, and/or at the sides of AV 110 as well, and such blockages 114 may also be visible in the visualization in region 106 of user-interface 102. Blockage 114 may represent a stopped car, or debris, or other object that prevents safe movement of AV 110 therethrough.

User-interface 102 further comprises another region 116 configured to show a view from a camera of AV 110. Only one such region 116 is shown in the figure merely for ease of illustration and not as a limitation. Any number of such regions 116 configured to show views from one or more cameras in AV 110 may be provided on user-interface 102 within the broad scope of the disclosure. Region 116 may also comprise warnings 118 superimposed on the camera views to alert the user (e.g., human user viewing user-interface 102) to possible blockages 114 and/or other features 108 in the camera's frame of view (e.g., viewfinder). In some examples, such warnings 118 may be displayed according to real-time calculations from the sensory data of the camera and predetermined logic that classifies the sensory data suitably. In some examples, warnings 118 may be determined from analysis of the camera's output indicating presence of blockage 114 or other features within the camera's frame of view.

User-interface 102 further comprises yet another region 120 configured to show one or more selectable options and one or more instructions. The selectable options may include, by way of examples and not limitations, the gear of AV 110 (e.g., reverse, drive, neutral, park, etc.), end-pose of AV 110 (e.g., after a maneuver), movement controls of AV 110 (e.g., pause, turn right, turn left, etc.), selection of sensors in AV 110 (e.g., data from camera on rear bumper, data from LIDAR on the top of AV 110, etc.), and other options that useful and/or relevant in remotely assisting AV 110 to move along a path. The instructions may include written text selected to be displayed based on real-time feedback from AV 110 and providing options to the user of user-interface 102 for further actions. In some examples, the intent of AV 110 may be displayed in region 120. For example, AV 110 may stop, and a caution that blockage 114 is detected in reversing path 126 may be displayed in text in region 120 of user-interface 102.

User-interface 102 further comprises yet another region 120 comprising a first selectable button 122 and a second selectable button 124. In an example, first selectable button 122 may be labeled “reverse” and second selectable button 124 may be labeled “exit reverse”. In various examples, continuously selecting first selectable button 122 triggers a workflow configured to move AV 110 in reverse gear along a reversing path 126. In the example shown, reversing path 126 is a straight-line path that serves to distance AV 110 from blockage 114 in a reverse direction. Releasing first selectable button 122 temporarily pauses the workflow, such that AV 110 stops moving in reverse gear along reversing path 126. Selecting second selectable button 124 terminates the workflow. In some examples, region 106 includes representations of spaces 128 and 130 around AV 110 relevant to safe movement of AV 110 along reversing path 126. In the example shown, space 128 is a circle, and any blockage 114 within the circle is a safety violation during any movement of AV 110. Similarly, space 130 is a cone behind AV 110, and any blockage 114 within the cone is a safety violation during a reverse maneuver of AV 110.

Note that any interaction of user 105 with user-interface 102, including selecting buttons, moving sliders, etc. translates to electronic signals that are sent from user-interface 102 to reverse planner 104 (and/or other components of computer-implemented system 100) using mechanisms known in the art either now or to be developed in the future. Thus, selections on user-interface 102 may be determined or sensed by reverse planner 104 appropriately from such signals and translated into appropriate commands (e.g., instructions).

FIG. 1B illustrates a simplified block diagram of a portion of user-interface 102 of FIG. 1A, according to some examples of the present disclosure. In the example shown, a slider 132 may be presented on user-interface 102. Slider 132 may be part of a rear bumper of AV 110 in an example visualization. Slider 132 may be configured to be moved toward or away from AV 110 by discrete predetermined equidistant spans 133 (e.g., 1 millimeter each on screen) using a drag and drop feature on user-interface 102 in some examples. Moving slider 132 by one of the discrete predetermined equidistant spans 133 on user-interface 102 is configured to cause AV 110 to move by a predetermined amount (e.g., 1 meter in road movement for each span on screen) along reversing path 126 in some examples. In some examples, reversing path 126 may be calculated based on the current pose of AV 110 and the selected end-pose of AV 110, without regard to slider 132. In some other examples, reversing path 126 may be decided by slider 132, and the end-pose calculated therefrom.

User-interface 102 may also present additional icons or representations, including a dashboard 134 including a region 136 for showing speed of AV 110, another region 138 with a slider (or other representation) indicative of a direction of AV 110 (e.g., similar to a steering wheel), yet another region 140 indicative of the gear of AV 110, and a representation 142 indicative of the currently active gear. In the example shown, the reverse gear is “lit up” (e.g., shown brighter than others, shown attenuated relative to others, etc.) indicating that AV 110 is currently in reverse gear. Note that the icons and representations as shown in the figure are merely examples and are intended to be limitations. Any suitable icon or representation may be used to provide the relevant information within the broad scope of the embodiments. For example, the lineup of gears in region 140 may be vertical rather than horizontal; speed may be displayed by an analog meter rather than numbers in region 136; etc.

FIG. 1C illustrates a simplified block diagram of user-interface 102 of FIG. 1A, according to some examples of the present disclosure. The example shown in the figure is substantially identical with user-interface 102 of FIG. 1A, except that a forward path 144 is also shown, indicative of a possible path calculated to avoid blockage 114. In various embodiments, such visualizations of alternate and/or possible paths may be presented on user-interface 102 for the user to select an appropriate end-pose, distance to travel along reversing path 126, and other selections relevant to assisting AV 110 to move around blockage 114.

FIG. 2 illustrates a simplified flow diagram representing operations 200 in an example protocol for reversing AV 110 under remote assistance supervision, according to some examples of the present disclosure. At 202, instructions are generated by a remote assistance platform, guided by user 105 clicking on or otherwise selecting and interacting with user-interface 102 to activate a workflow for reversing AV 110, thereupon shifting the gear in AV 110 to reverse (e.g., from park or drive, etc.). At 204, an end-pose may be presented for selection. The end-pose may comprise a particular direction of AV 110 and the gear and other settings associated therewith. In some examples, the end-pose selection option may be removed to reduce the overall time for workflow execution of the reverse maneuver. In various examples, user 105 may be able to preview and modify the end-pose as desired and based on particular needs.

At 206, reversing path 126 may be visualized in view of the selected end-pose. In some examples, reversing path 126 may be initially a default path, for example, a straight-line emanating from the rear of AV 110, which may be presented on user-interface 102 as an option for user 105. In some examples, no default path may be presented. In such examples, user 105 may consciously select the best possible end-pose at 204, avoiding failure modes caused by overshooting the desired end-pose or only reversing a small increment and shifting back to drive. Such end-pose selections or path selections can be performed before or shortly after AV 110 switches to the reverse gear in some examples.

In some examples, the default reversing path 126 may be a fixed length straight-line path, for example, 1 meter. Such a default path may allow speeding up the workflow assuming the default fixed length will be sufficient to resolve blockage 114. In some other examples, a greedy default path having the longest collision-free path up to a maximum length may be presented as an option for reversing path 126. User 105 may be able to change the default path suitably to tailor reversing path 126 to the actual conditions around AV 110. For example, blockages 114 may be present in the default path, and user 105 may change the default path suitably to avoid such blockages 114. In some examples, user 105 may change a direction of the steering wheel using the slider in region 138 of user-interface 102.

At 208, user 105 may continuously authorize the reverse maneuver. In some examples, the authorization may be achieved by continuously holding (e.g., selecting) first selectable button 122 on user-interface 102 manually. In some examples, a charging icon may be displayed on or alongside first selectable button 122 to indicate progress of the reverse maneuver (e.g., charging icon shows 100% charged when reverse maneuver is completed). In some other examples, the authorization may be achieved by continuously holding (e.g., selecting) a key on a keyboard connected to computer-implemented system 100. In some other examples, the authorization may be achieved by continuously holding (e.g., selecting) a key on a computer mouse connected to computer-implemented system 100.

In some examples, continuous authorization of the reverse maneuver may be achieved after checking the feasibility and safety of reversing path 126. In various examples, AV 110 may move continuously until first selectable button 122 is released (e.g., unselected). In some examples, holding (e.g., selecting) first selectable button 122 triggers transmission of discrete signals at a signal rate above a predetermined rate threshold (e.g., less than 1 second between two consecutive signals). In some other examples, holding (e.g., selecting) first selectable button 122 triggers transmission of a continuous-time signal for the duration of the selected state. In some other examples, a latency (e.g., lag, duration between consecutive signals) that exceeds a predetermined threshold (e.g., 1 second) may be sufficient to de-authorize the reverse maneuver. In some examples, if the latency (e.g., lag, duration, time difference) between two consecutive selections of first selectable button 122 exceeds 1 second, the reverse maneuver may be paused. In some examples, a timer starts upon receipt of one of the signals, and the timer stops when the next consecutive signal is received; a duration of the timer that exceeds 1 second may result in pausing the reverse maneuver. In some examples, user 105 may re-authorize the reverse maneuver toward the end-pose when the latency is within the 1 second threshold.

In some examples, forward path 144 may be calculated and visualized in real-time according to the movement of AV 110 to indicate whether the reverse maneuver would be effective to clear blockage 114. In some such examples, user 105 may release first selected button 122 when AV 110 reaches a pose that allows forward path 144 to clear blockage 114.

In some examples, at 210, reversing path 126 may be adjusted if it is determined, by AV 110, other systems including the remote assistance platform, and/or user 105 that reversing path 126 is infeasible or unsafe. In some such examples, operations 200 may be overridden to stop AV 110. Operations 206, 208 and 210 may be repeated until a desired end-pose of AV 110 is reached. For example, reverse path 126 may be continuously visualized during execution of the reverse maneuver. At 212, AV 110 shifts to drive gear. At 214, forward path 144 may be visualized on user-interface 102. The desired end-pose of AV 110 may be informed by forward path 144 visualized on user-interface 102.

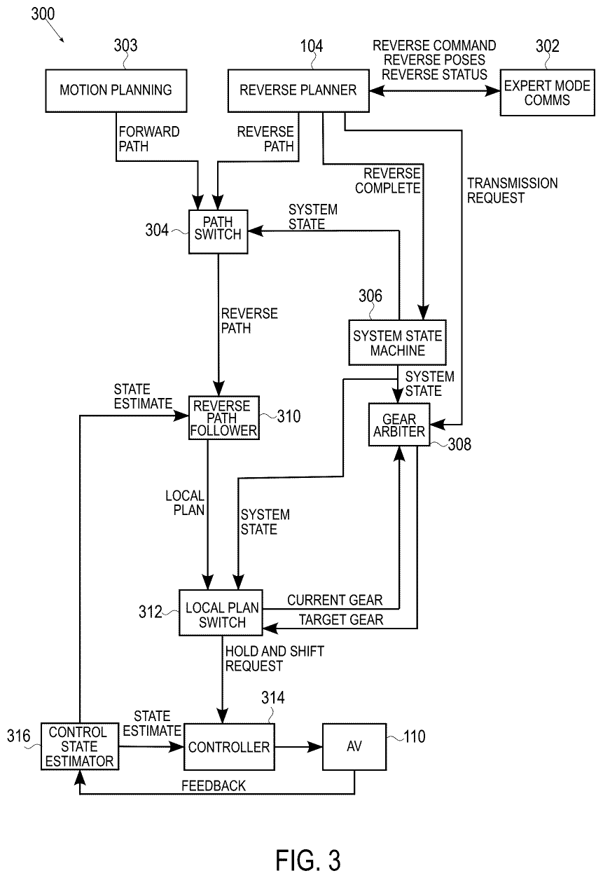

FIG. 3 illustrates a simplified block diagram of a portion 300 of computer-implemented system 100 for reversing AV 110 under remote assistance supervision, according to some examples of the present disclosure. An expert mode communications block 302 may be communicatively coupled to reverse planner 104. Expert mode communications block 302 may communicate reverse commands, reverse poses, reverse status, etc. with reverse planner 104 and present to user-interface 102 suitably. Reverse planner 104 and motion planning block 303 publish reversing path 126 and forward path 144 respectively to a path switch 304. Reverse planner 104 may also publish a status (e.g., reverse complete, pre-reverse, pre-drive, etc.) a system state machine (SSM) 306. SSM 306 may publish the system state (e.g., temporary fault, soft stop, hard stop) to path switch 304. Depending on the reverse commands (e.g., switch gear to reverse), reverse planner 104 may publish a transmission request to a gear arbiter 308. Gear arbiter 308 may also receive the system status from SSM 306.

Upon initiation of the workflow for a reverse maneuver, path switch 304 may publish reversing path 126 to a reverse path follower 310, which may be communicatively coupled to a local plan switch 312. Based on the selected path, reverse path follower 310 may publish a local plan to local plan switch 312 (e.g., move for 2 seconds along reversing path 126 in a straight-line without turning the steering, etc.) In some examples, local plan switch 312 may be in a planning stack of AV 110. Local plan switch 312 may communicate with SSM 306 to determine system state, local plan switch 312 may also communicate with gear arbiter 308 to determine the current gear and the target gear, presenting hold and shift requests appropriately to a controller 314 of AV 110. For example, local plan switch 312 may determine the appropriate gear to use based on the system state and the local plan and communicate the target gear to gear arbiter 308 and a shift (or hold) request to controller 314.

A control state estimator 316 may continually receive feedback from AV 110 and communicate a state estimate to reverse path follower 310, which may incorporate the information into the local plan sent to local plan switch 312. For example, the state estimate may indicate that AV 110 is moving too fast and approaching a blockage 114; reverse path follower 310 may appropriate modify the local plan to slow down AV 110 and communicate the updated plan to local plan switch 312. Control state estimator 316 may also send the state estimate to controller 314 for appropriate feedback actions. For example, the state estimate may indicate that AV 110 is moving too fast and approaching a blockage 114; controller 314 may use the information to slow down AV 110 directly. Note that only a few actions and reactions are shown and described in the figure. Other actions and reactions including communication of various other data not shown in the figure may be included within the broad scope pf the disclosure herein.

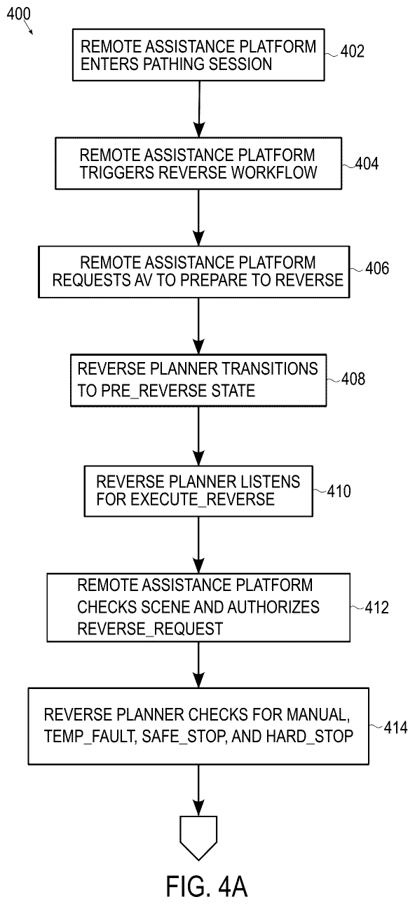

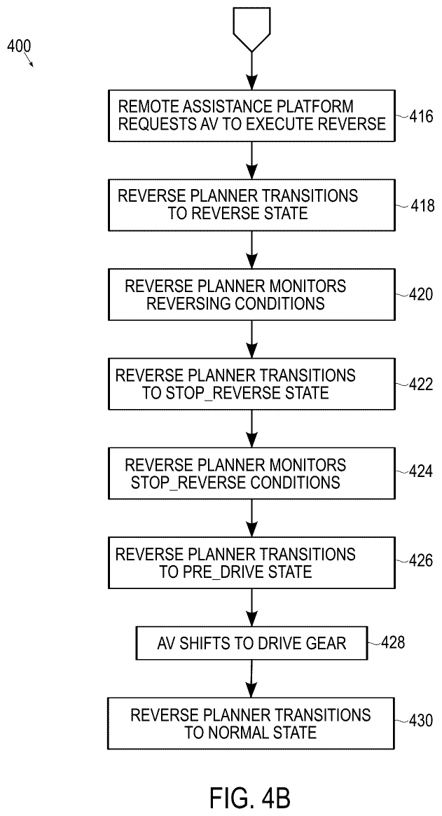

FIGS. 4A and 4B are simplified flow diagrams representing operations 400 in an example protocol for reversing AV 110 under remote assistance supervision, according to some examples of the present disclosure. At 402, the remote assistance platform enters a pathing session activated by user 105 on user-interface 102. In some embodiments, the pathing session is activated by opening a reverse workflow window of user-interface 102. In some examples, entering the reverse workflow may trigger certain configuration operations, for example, the remote assistance platform may send an end-pose to AV 110, which may respond with reverse path 126, upon which the remote assistance platform may inspect the path visualization (e.g., present it to user 105), upon which the remote assistance platform may continuously authorize (or prepare to continuously authorize) the reverse maneuver.

When the pathing session is entered, SSM 306 transitions to REMOTE_PATHING state and then to REMOTE_STAGING state. SSM 306 communicates the updated state to path switch 304, gear arbiter 308, and local plan switch 312 appropriately. At 404, the remote assistance platform triggers the “reverse” workflow that initiates the reverse maneuver of AV 110. In some embodiments, the workflow is triggered when user 105 clicks (e.g., selects) the “reverse gear” button in region 140 on a user-interface 102.

At 406, the remote assistance platform requests AV 110 to prepare for a reverse maneuver. The instructions are also published suitably to reverse planner 104 and SSM 306. SSM 306 listens for PREPARE_FOR_REVERSE instructions. At 408, in response to the instructions, reverse planner 104 transitions to a PRE_REVERSE state, in which reverse planner 104 requests gear shift to reverse, which is serviced by gear arbiter 308. SSM 306 transitions to REMOTE_REVERSE upon receipt of PREPARE_FOR_REVERSE instruction. Reverse planner 104 listens for instructions to execute the reverse maneuver (e.g., EXECUTE_REVERSE instructions) at 410. At 412, the status of reverse planner 104 is further communicated to the remote assistance platform, which then enables first selectable button 122 on user-interface 102. User 105 may check the scene on user-interface 102 and through the remote assistance platform, authorize a REVERSE_REQUEST, for example, by clicking a “Execute” button on user-interface 102.

At 414, reverse planner 104 subscribes to SSM 306, listening (e.g., checking) for various system states (e.g., conditions) that can stop execution of the reverse maneuver. Example system states include manual state (e.g., MANUAL state where AV 110 is controlled by a driver behind the steering wheel), temporary fault (e.g., TEMP_FAULT state), safe stop (e.g., SAFE_STOP state), and hard stop (e.g., HARD_STOP state). If SSM 306 enters MANUAL, TEMP_FAULT, SAFE_STOP, or HARD_STOP state, reverse planner 104 transitions to a STOP_DRIVE state, which brings AV 110 to a stop and then shifts to the drive gear. Reverse planner 104 may remain in STOP_DRIVE state until all of the following conditions are met: steering wheel angle is below a predetermined angle threshold (e.g., 30 degrees), vehicle speed is below a predetermined speed threshold (e.g., 0.1 m/s) and a predetermined time (e.g., 2.5 seconds) has elapsed without additional instructions since a last received instruction by reverse planner 104. If more than another predetermined time (e.g., 3 seconds) has elapsed without additional instructions, reverse planner 104 may timeout and abort the workflow. In various examples, reverse planner 104 may enter the STOP_DRIVE state at any time during the workflow when the system state published by SSM 306 is one of MANUAL, TEMP_FAULT, SAFE_STOP, or HARD_STOP states.

At 416, remote assistance platform may translate the clicking of the “Execute” button into instructions to execute the reverse maneuver (e.g., EXECUTE_REVERSE instruction), which is sent to reverse planner 104 through expert mode communications block 302. Reverse planner 104 may remain in the PRE_REVERSE state until the following conditions are met: AV 110 has shifted to reverse gear, the EXECUTE_REVERSE instruction is received, and a predetermined time (e.g., 2.5 seconds) has elapsed without additional instructions. If more than another predetermined time (e.g., 10 seconds) has elapsed without additional instructions, reverse planner 104 may timeout and abort the workflow. At 418, once all conditions are met (e.g., EXECUTE_REVERSE instruction received), reverse planner 104 may transition to a REVERSE state, causing AV 110 to start moving in reverse gear along reversing path 126.

At 420, reverse planner 104 may continuously monitor conditions to execute the reverse maneuver (or conditions that can cause the reverse maneuver to terminate). For example, reverse planner 104 may continuously check for collisions in reversing path 126 against prediction intents. Reverse planner 104 remains in REVERSE state unless any one of the following conditions is met: AV 110 has traveled a predetermined target distance (e.g., within 0.1 meter of the target distance), a collision is detected in reversing path 126, or more than a predetermined time (e.g., 10 seconds more than the time for the reverse maneuver) has elapsed without additional instructions.

At 422, if any one condition is met, reverse planner 104 may transition to a STOP_REVERSE state. In the STOP_REVERSE state, AV 110 is brought to a complete halt. At 424, reverse planner 104 remains in the STOP_REVERSE state, monitoring for the following conditions: steering wheel angle is below a predetermined threshold (e.g., 30 degrees), speed of AV 110 is below a predetermined threshold (e.g., 0.1 m/s), and a predetermined time (e.g., 2.5 seconds) has elapsed without additional instructions. Until all these conditions are met, reverse planner 104 remains in the STOP_REVERSE state. In various examples, reaching the end-pose also causes reverse planner 104 to transition to the STOP_REVERSE state. At 426, reverse planner 104 transitions to a PRE_DRIVE state. In the PRE_DRIVE state, reverse planner 104 requests shifting of the gear of AV 110 to drive. The request is serviced by gear arbiter 308. At 428, AV 110 shifts to drive gear. At 430, reverse planner 104 transitions back to its normal state.

In various examples, reverse planner 104 may timeout if the following time thresholds are exceeded in the corresponding state: 3 seconds in the STOP_DRIVE state; 20 seconds in the PRE_REVERSE state; 10 seconds in the REVERSE state. In various examples, reverse planner 104 may be configured to spend at least the following time thresholds in the corresponding state before executing instructions associated therewith: 2.5 seconds in the STOP_DRIVE state, PRE_REVERSE state, and STOP_REVERSE state. The values of the time thresholds listed herein are merely for example purposes; any suitable time threshold can be used for the corresponding state based on particular needs within the broad scope of the disclosure herein.

In various examples, when reverse planner 104 transitions from one state to another, reverse planner 104 may publish a reason for the transition. Example reasons include: execute reverse maneuver instructions received (e.g., EXECUTE_REVERSE_RECEIVED); collision in path (e.g., PAUSED_COLLISION_IN_PATH); pause command received (e.g., PAUSED_COMMAND_RECEIVED); reverse complete (e.g., ABORT_REVERSE_COMPLETE); abort command received (e.g., ABORT_COMMAND_RECEIVED). Various other reasons may also be included as appropriate within the broad scope of the disclosure herein.

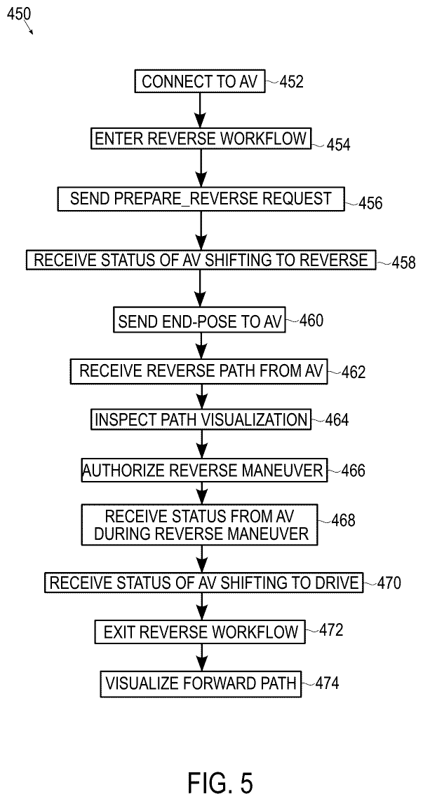

FIG. 5 illustrates a simplified flow diagram representing operations 450 in another example protocol for reversing an AV under remote assistance supervision, according to some examples of the present disclosure. At 452, computer-implemented system 100 connects to AV 110. At 454, computer-implemented system 100 enters a reverse workflow. At 456, computer-implemented system 100 sends a PREPARE-REVERSE request to AV 110. At 458, AV 110 gear shifts to reverse and sends a status update to computer-implemented system 100, which receives the status of AV 110 shifting to reverse. At 460, computer-implemented system 100 may send a selected end-pose to AV 110. At 462, AV 110 responds with reverse path 126, which computer-implemented system 100 may receive appropriately. At 464, computer-implemented system 100 may inspect the path visualization, for example, comparing reverse path 126 with a predicted path, or selected path, etc. At 466 computer-implemented system 100 authorizes reverse maneuver. In some examples, the reverse maneuver is authorized so long as selectable button 122 remains in a “selected” state (e.g., user 105 may continuously hold it manually in a selected state in some examples). At 468, AV 110 executes the reverse maneuver along reverse path 126. In some examples, AV 110 may substantially continuously check for off-nominal pausing or stopping conditions during the reverse maneuver. When the end-pose is reached, AV 110 may come to a stop and shift gear to drive. At 470, computer-implemented system 100 may receive status of AV 110 shifting to drive. At 472, computer-implemented system 100 and AV 110 may exit the reverse workflow. In some examples, exiting the workflow may comprise handing back of control of AV 110 to controller 314 by reverse planner 104. In some other examples, exiting the workflow may comprise a selection by user 105 to exit the reverse maneuver flow, in which case, AC 110 may shift to drive as specified at 470, after receiving such instruction in 472. At 474, computer-implemented system 100 may visualize forward path 144.

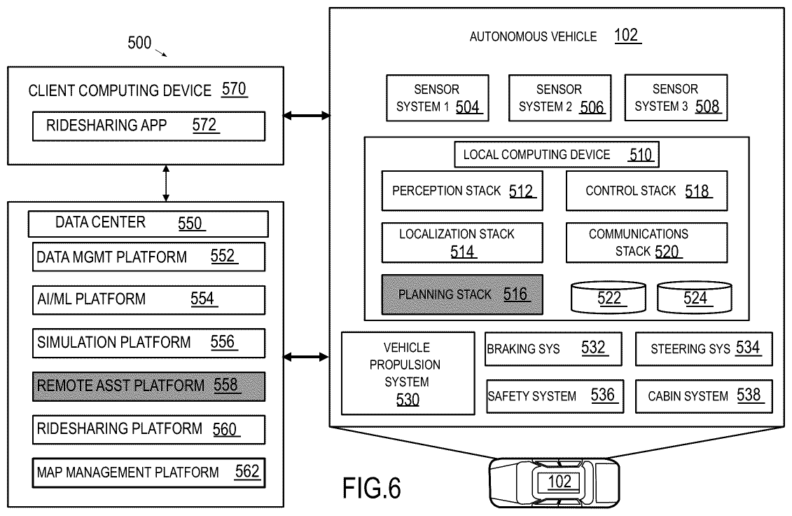

FIG. 6 illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 500 includes an AV 110, a data center 550, and a client computing device 570. The AV 110, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 110 can navigate about roadways without a human driver based on sensor signals generated by multiple sensor systems 504, 506, and 508. The sensor systems 504-508 can include different types of sensors and can be arranged about the AV 110. For instance, the sensor systems 504-508 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other examples may include any other number and type of sensors.

AV 110 can also include several mechanical systems that can be used to maneuver or operate AV 110. For instance, the mechanical systems can include vehicle propulsion system 530, braking system 532, steering system 534, safety system 536, and cabin system 538, among other systems. Vehicle propulsion system 530 can include an electric motor, an internal combustion engine, or both. The braking system 532 can include an engine brake, a wheel braking system (e.g., a disc braking system that utilizes brake pads), hydraulics, actuators, and/or any other suitable componentry configured to assist in decelerating AV 110. The steering system 534 can include suitable componentry configured to control the direction of movement of the AV 110 during navigation. Safety system 536 can include lights and signal indicators, a parking brake, airbags, and so forth. The cabin system 538 can include cabin temperature control systems, in-cabin entertainment systems, and so forth. In some examples, the AV 110 may not include human driver actuators (e.g., steering wheel, handbrake, foot brake pedal, foot accelerator pedal, turn signal lever, window wipers, etc.) for controlling the AV 110. Instead, the cabin system 538 can include one or more client interfaces (e.g., Graphical User-interfaces (GUIs), Voice User-interfaces (VUIs), etc.) for controlling certain aspects of the mechanical systems 530-538.

AV 110 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 110; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512 a mapping and localization stack 514, a planning stack 516, a control stack 518, a communications stack 520, a High Definition (HD) geospatial database 522, and an AV operational database 524, among other stacks and systems.

Perception stack 512 can enable the AV 110 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 522, other components of the AV, and other data sources (e.g., the data center 550, the client computing device 570, third-party data sources, etc.). The perception stack 512 can detect and classify objects and determine their current and predicted locations, speeds, directions, and the like. In addition, the perception stack 512 can determine the free space around the AV 110 (e.g., to maintain a safe distance from other objects, change lanes, park the AV, etc.). The perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some examples, the AV 110 can compare sensor data captured in real-time by the sensor systems 504-508 to data in the HD geospatial database 522 to determine its precise (e.g., accurate to the order of a few centimeters or less) position and orientation. The AV 110 can focus its search based on sensor data from one or more first sensor systems (e.g., GPS) by matching sensor data from one or more second sensor systems (e.g., LIDAR). If the mapping and localization information from one system is unavailable, the AV 110 can use mapping and localization information from a redundant system and/or from remote data sources.

The planning stack 516 can determine how to maneuver or operate the AV 110 safely and efficiently in its environment. For example, the planning stack 516 can receive the location, speed, and direction of the AV 110, geospatial data, data regarding objects sharing the road with the AV 110 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 110 from one point to another. The planning stack 516 can determine multiple sets of one or more mechanical operations that the AV 110 can perform (e.g., go straight at a specified speed or rate of acceleration, including maintaining the same speed or decelerating; power on the left blinker, decelerate if the AV is above a threshold range for turning, and turn left; power on the right blinker, accelerate if the AV is stopped or below the threshold range for turning, and turn right; decelerate until completely stopped and reverse; etc.), and select the best one to meet changing road conditions and events. If something unexpected happens, the planning stack 516 can select from multiple backup plans to carry out. For example, while preparing to change lanes to turn right at an intersection, another vehicle may aggressively cut into the destination lane, making the lane change unsafe. The planning stack 516 could have already determined an alternative plan for such an event, and upon its occurrence, help to direct the AV 110 to go around the block instead of blocking a current lane while waiting for an opening to change lanes. In various examples, planning stack 516 may include reverse planner 104 and other blocks as described in FIG. 3. In some other examples, planning stack 516 may include some (but not all) blocks as described in FIG. 3, with reverse planner 104 and expert mode communication block 302 (among some other blocks) being outside planning stack 516.

The control stack 518 can manage the operation of the vehicle propulsion system 530, the braking system 532, the steering system 534, the safety system 536, and the cabin system 538. In some examples, controller 314 and control state estimator 316 may be comprised in control stack 518. The control stack 518 can receive sensor signals from the sensor systems 504-508 as well as communicate with other stacks or components of the local computing device 510 or a remote system (e.g., the data center 550) to effectuate operation of the AV 110. For example, the control stack 518 can implement the final path or actions from the multiple paths or actions provided by the planning stack 516. This can involve turning the routes and decisions from the planning stack 516 into commands for the actuators that control the AV's steering, throttle, brake, and drive unit.

The communication stack 520 can transmit and receive signals between the various stacks and other components of the AV 110 and between the AV 110, the data center 550, the client computing device 570, and other remote systems. In some examples, expert mode communication block 302 may be part of communication stack 520. The communication stack 520 can enable the local computing device 510 to exchange information remotely over a network, such as through an antenna array or interface that can provide a metropolitan WI-FI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 522 can store HD maps and related data of the streets upon which the AV 110 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 524 can store raw AV data generated by the sensor systems 404-408 and other components of the AV 110 and/or data received by the AV 110 from remote systems (e.g., the data center 550, the client computing device 570, etc.). In some examples, the raw AV data can include HD LIDAR point cloud data, image or video data, RADAR data, GPS data, and other sensor data that the data center 450 can use for creating or updating AV geospatial data.

The data center 550 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 550 can include one or more computing devices remote to the local computing device 510 for managing a fleet of AVs and AV-related services. For example, in addition to managing the AV 110, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 110 and the client computing device 570. These signals can include sensor data captured by the sensor systems 504-508, roadside assistance requests, software updates, ridesharing pick-up and drop-off instructions, and so forth. In this example, the data center 550 includes one or more of a data management platform 552, an artificial intelligence/Machine Learning (AI/ML) platform 554, a simulation platform 556, a remote assistance platform 558, a ridesharing platform 560, and a map management platform 562, among other systems.

Data management platform 552 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 110, the simulation platform 556, the remote assistance platform 558, the ridesharing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 110, the remote assistance platform 558, the ridesharing platform 560, the map management platform 562, and other platforms and systems. The simulation platform 556 can replicate a variety of driving environments and/or reproduce real-world scenarios from data captured by the AV 110, including rendering geospatial information and road infrastructure (e.g., streets, lanes, crosswalks, traffic lights, stop signs, etc.) obtained from the map management platform 562; modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 110. For example, in response to an output of the AI/ML platform 554 or other system of the data center 550, the remote assistance platform 558 can prepare instructions for one or more stacks or other components of the AV 110.

The ridesharing platform 560 can interact with a customer of a ridesharing service via a ridesharing application 572 executing on the client computing device 470. The client computing device 570 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general-purpose computing device for accessing the ridesharing application 572. The client computing device 570 can be a customer's mobile computing device or a computing device integrated with the AV 110 (e.g., the local computing device 510). The ridesharing platform 560 can receive requests to be picked up or dropped off from the ridesharing application 572 and dispatch the AV 110 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 52, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some examples, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 110 in transit en route to a pick-up or drop-off location, and so on.

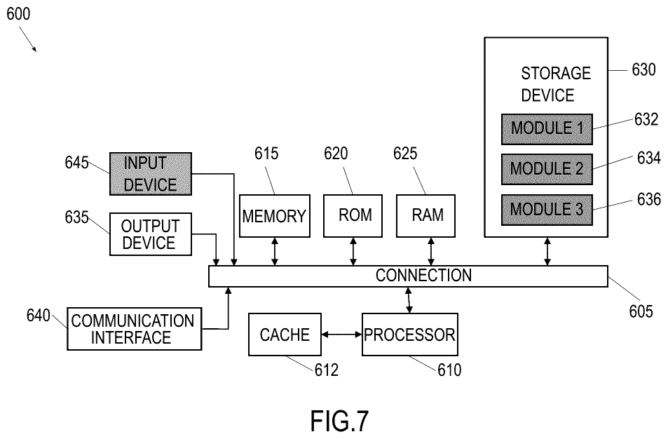

FIG. 7 illustrates an example processor-based system with which some aspects of the subject technology may be implemented. For example, processor-based system 600 may be any computing device making up, or any component thereof in which the components of the system are in communication with each other using connection 605. Connection 605 may be a physical connection via a bus, or a direct connection into processor 610, such as in a chipset architecture. Connection 605 may also be a virtual connection, networked connection, or logical connection. In another example, processor-based system 600 may be any electronic device with a display, and/or other peripherals such as a computer mouse and/or keyboard.

In some examples, computing system 600 is a distributed system in which the functions described in this disclosure may be distributed within a datacenter, multiple data centers, a peer network, etc. In some examples, one or more of the described system components represents many such components each performing some or all of the function for which the component is described. In some examples, the components may be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 may include a cache of high-speed memory 612 connected directly with, in close proximity to, or integrated as part of processor 610.

Processor 610 may include any general-purpose processor and a hardware service or software service, such as a module 632 stored in storage device 630, with instructions associated with reverse planner 104, configured to control processor 610 as well as a special-purpose processor where software instructions are incorporated into the actual processor design. Other modules 634-636 may include, by way of example and not as limitations, simulation engines, physics engines, etc., including instructions for processor 610 to perform the operations as described in the preceding figures.

Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as user-interface 102, a microphone for speech, a touch-sensitive screen for gesture or graphical input, keyboard, mouse, motion input, speech, etc. Computing system 600 may also include output device 635, which may be one or more of a number of output mechanisms known to those of skill in the art. In some instances, multimodal systems may enable a user to provide multiple types of input/output to communicate with computing system 600. Computing system 600 may include communications interface 640, which may generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more GNSS receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer-readable media which may store data that are accessible by a computer, such as magnetic cassettes, flash memory cards, solid-state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Static RAM (SRAM), Dynamic RAM (DRAM), ROM, Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 may include software services, servers, services, etc., that when the code that defines such software is executed by the processor 610, it causes the system 600 to perform a function. In some examples, a hardware service that performs a particular function may include the software component stored in a computer-readable medium in connection with the necessary hardware components, such as processor 610, connection 605, output device 635, etc., to carry out the function.

Examples within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including Personal Computers (PCs), hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Selected Examples

Example 1 provides a computer-implemented system, comprising: one or more non-transitory computer-readable media storing instructions, when executed by one or more processing units, cause the one or more processing units to perform operations comprising: providing instructions to shift a gear of a vehicle from drive to reverse; receiving, from the vehicle, an end-pose and a reversing path for the vehicle; calculating a reverse maneuver for the vehicle to move in reverse gear based on the end-pose and the reversing path; transmitting, to the vehicle, signals to move the vehicle in reverse gear, the signals being transmitted at a signal rate above a predetermined rate threshold; and stopping the vehicle in response to reaching the end-pose.

Example 2 provides the computer-implemented system of example 1, wherein the instructions further comprise generating a visualization of the reversing path on a user-interface.

Example 3 provides the computer-implemented system of any one of examples 1-2, wherein a lag between two consecutive signals that are transmitted is less than 1 second.

Example 4 provides the computer-implemented system of any one of examples 1-3, further comprising checking feasibility and safety of the reversing path.

Example 5 provides the computer-implemented system of example 4, further comprising determining that the reversing path is at least one of infeasible or safe; and adjusting the reversing path until the reversing path is feasible and safe.

Example 6 provides the computer-implemented system of any one of examples 1-5, wherein: the reversing path is a straight-line path, and adjusting the reversing path comprises changing a length of the straight-line path.

Example 7 provides the computer-implemented system of any one of examples 1-6, further comprising: calculating a forward path of the vehicle moving in drive gear based on a pose of the vehicle during the reverse maneuver; and providing instructions to shift the gear of the vehicle from reverse to drive.

Example 8 provides the computer-implemented system of any one of examples 1-7, wherein the operations further comprise: determining that a button on a user-interface is held in a selected state; continuing transmitting signals to the vehicle in response to the button being held in the selected state; determining that the button on the user-interface is released from the selected state; and stopping transmitting signals to the vehicle in response to the button being released from the selected state such that the vehicle comes to a halt without shifting gear.

Example 9 provides the computer-implemented system of example 8, wherein: the button is a first button, and providing instructions to shift the gear comprises determining that a second button on the user-interface is selected.

Example 10 provides the computer-implemented system of example 9, wherein the operations further comprise: activating a workflow in a reverse planner in response to the second button being selected, and the reverse planner comprises one or more logic circuits for generating commands configured to instruct a controller controlling the vehicle.

Example 11 provides the computer-implemented system of example 1-10, wherein the instructions to shift the gear of the vehicle from drive to reverse activate a workflow comprising: requesting, by a remote assistance platform, the vehicle to prepare for the reverse maneuver; listening, by a reverse planner, for instructions to execute the reverse maneuver; checking, by the reverse planner, for conditions that stop execution of the reverse maneuver; transitioning the reverse planner to a pre-reverse state; generating, by the remote assistance platform, the instructions to execute the reverse maneuver; transitioning the reverse planner to a reverse state; monitoring, by the reverse planner, conditions to execute the reverse maneuver; and executing, by the reverse planner, the instructions to execute the reverse maneuver.

Example 12 provides the computer-implemented system of example 11, wherein the conditions that stop execution of the reverse maneuver include: receiving instructions alerting to a state comprising at least one of manual state, temporary fault, safe stop, and hard stop; steering wheel angle is below a predetermined angle threshold; vehicle speed is below a predetermined speed threshold; and a predetermined time has elapsed without additional instructions since a last received instruction by the reverse planner.

Example 13 provides the computer-implemented system of example 12, wherein: the predetermined time is a first time, the reverse planner timeouts if a second time is exceeded without additional instructions.

Example 14 provides the computer-implemented system of any one of examples 11-13, wherein the reverse planner does not transition to the pre-reverse state if any one condition that stops execution of the reverse maneuver exists.

Example 15 provides the computer-implemented system of any one of examples 11-14, wherein the conditions to execute the reverse maneuver comprise: the vehicle has shifted the gear to reverse; instructions to execute the reverse maneuver have been received by the reverse planner; a predetermined first time has elapsed without additional instructions since the instructions to reverse were received by the reverse planner; and a predetermined second time has not elapsed without additional instructions since the instructions to reverse were received by the reverse planner, the second time being longer than the first time.

Example 16 provides the computer-implemented system of any one of examples 11-15, wherein executing the instructions to execute the reverse maneuver comprises: checking for collision against prediction intents during movement by the vehicle in reverse gear; remaining in the reverse state unless at least one of the following conditions is met: (i) the vehicle has traveled a predetermined target distance, (ii) the reverse planner detects a collision in the reversing path, or (iii) more than a predetermined time has elapsed since instructions shift the gear to reverse were provided; and pausing the reverse maneuver when the reverse planner detects a collision, the pausing comprising halting the vehicle without shifting gear.

Example 17 provides the computer-implemented system of any one of examples 11-16, wherein the workflow further comprises: transitioning the reverse planner to a stop reverse state in response to determining that the conditions to execute the reverse maneuver are not met, monitoring, by the reverse planner, conditions to transition out of the stop reverse state, and transitioning the reverse planner to a pre-drive state in response to determining that the conditions to transition out of the stop reverse state are met.

Example 18 provides the computer-implemented system of example 17, wherein the conditions to transition out of the stop reverse state include: steering wheel angle is below a predetermined angle threshold; vehicle speed is below a predetermined speed threshold; and a predetermined time has elapsed without additional instructions since a last received instruction by the reverse planner.

Example 19 provides the computer-implemented system of example 17, wherein the reverse planner does not transition to the pre-drive state if any one of the conditions to transition out of the stop reverse state does not exist.

Example 20 provides the computer-implemented system of any one of examples 17-19, wherein, in the pre-drive state, the reverse planner provides instructions to shift the gear to drive.

Example 21 provides the computer-implemented system of any one of examples 11-20, the workflow further comprising, in the pre-reverse state: requesting, by the reverse planner, shifting the gear to reverse; and publishing, by the reverse planner, a waiting-for-release state, wherein publishing the waiting-for-release state triggers the first button to be available for holding to the selected state.

Example 22 provides a method, comprising: generating, by a computer-implemented system, instructions to initiate a workflow in response to a first button on a user-interface transitioning from an unselected state to a selected state, the workflow being configured to enable a vehicle to reverse from an initial pose to a target pose; generating, by the computer-implemented system, a visual representation of a path of the vehicle from the first pose to the target pose; monitoring, by the computer-implemented system, a state of a second button on the user-interface, wherein the workflow is terminated in response to the state of the second button changing from a selected state to an unselected state after a predetermined duration; and generating, by the computer-implemented system, instructions to move the vehicle along the path by a distance as calculated according to a movement of a slider on the user-interface, the instructions to move the vehicle being generated as long as the second button is in the selected state.

Example 23 provides the method of example 22, further comprising pausing, by the computer-implemented system, generating instructions to move the vehicle in response to the second button being released from the selected state, wherein pausing does not include shifting a gear of the vehicle from reverse to drive.

Example 24 provides the method of any one of examples 22-23, further comprising: pausing, by the computer-implemented system, the workflow in response to a system state machine transitioning from a remote reverse state to a temporary fault state, wherein the system state machine transitions to the temporary fault state in response to a fault being detected in the vehicle; and resuming, by the computer-implemented system, the workflow in response to the system state machine transitioning from the temporary fault state to the reverse state.

Example 25 provides the method of any one of examples 22-24, further comprising: stopping, by the computer-implemented system, the workflow in response to the system state machine transitioning to a safe stop state; and shifting a gear in the vehicle from reverse to drive.

Example 26 provides the method of any one of examples 22-25, further comprising: stopping, by the computer-implemented system, the workflow in response to the system state machine transitioning to a hard stop state; and bringing, by the computer-implemented system, the vehicle to a complete halt.

Example 27 provides the method of any one of examples 22-26, further comprising pausing, by the computer-implemented system, the workflow for an indefinite period of time, until blockages behind the vehicle in the path are cleared.

Example 28 provides the method of example 27, wherein the blockages are sensed by cameras in a rear portion of the vehicle.

Example 29 provides the method of any one of examples 22-28, further comprising calculating, by the computer-implemented system, another target pose in response to the blockages being sensed.

Example 30 provides the method of any one of examples 22-29, further comprising resuming, by the computer-implemented system, the workflow in response to network and environmental conditions without shifting a gear of the vehicle from reverse to drive.

Example 31 provides the method of any one of examples 22-30, further comprising: stopping, by the computer-implemented system, the workflow in response to a third button on the user-interface being selected, the third button indicative of an abort condition; and generating, by the computer-implemented system, instructions to shift a gear of the vehicle from reverse to drive.

Example 32 provides an electronic device, comprising: a display; one or more processors; a memory; and one or more programs, wherein the one or more programs are stored in the memory and configured to be executed by the one or more processors, the one or more programs including instructions for displaying a user interface, wherein: the user interface comprises: a first region configured to show a location of a vehicle and surrounding features; a second region configured to show one or more selectable options and one or more instructions; a third region configured to show a view from a camera of the vehicle; and a fourth region comprising a first selectable button and a second selectable button, triggering a workflow configured to move the vehicle in reverse gear along a selected path in response to selecting the first selectable button, maintaining execution of the workflow in response to holding the first selectable button in a selected state, temporarily pausing the workflow in response to releasing the first selectable button, such that the vehicle stops moving in reverse gear along the selected path, and terminating the workflow in response to selecting the second selectable button.

Example 33 provides the electronic device of example 32, wherein holding the first selectable button in the selected state comprises pressing down on the first selectable button manually.

Example 34 provides the electronic device of any one of examples 32-33, wherein the fourth region is at a bottom portion of the user-interface.

Example 35 provides the electronic device of any one of examples 32-34, wherein the first region is further configured to show a visualization of a reverse path and a forward path of the vehicle.

Example 36 provides the electronic device of any one of examples 32-35, wherein the first region is further configured to show blockages around the vehicle.

Example 37 provides the electronic device of any one of examples 32-36, wherein: the first region is configured further to show a slider coupled to a visualization of the vehicle, the slider is configured to be moved toward or away from the vehicle by discrete predetermined equidistant spans, moving the slider by one of the discrete predetermined equidistant spans is configured to cause the vehicle to move by a predetermined amount along a selected path.

Example 38 provides the electronic device of any one of examples 32-37, wherein: the camera is rear-mounted on the vehicle, the third region further includes warnings determined from analysis of the camera's output, and the warnings indicate presence of blockage within the camera's frame of view.

Example 39 provides the electronic device of any one of examples 32-38, wherein: a first one of the selectable options includes choosing the selected path, and a second one of the selectable options includes choosing a target end-pose for the vehicle along the selected path.

Example 40 provides the electronic device of any one of examples 32-39, wherein the selected path includes a default path preselected by the computer-implemented system.

Example 41 provides the electronic device of any one of examples 32-40, wherein the first region includes representations of spaces around the vehicle relevant to safe movement of the vehicle along the selected path.

The various examples described above are provided by way of illustration only and should not be construed to limit the scope of the disclosure. For example, the principles herein apply equally to optimization as well as general improvements. Various modifications and changes may be made to the principles described herein without following the example examples and applications illustrated and described herein, and without departing from the spirit and scope of the disclosure. Claim language reciting “at least one of” a set indicates that one member of the set or multiple members of the set satisfy the claim.

What is claimed is:

1. A computer-implemented system, comprising:
one or more non-transitory computer-readable media storing instructions, when executed by one or more processing units, cause the one or more processing units to perform operations comprising:
providing instructions to shift a gear of a vehicle from drive to reverse;
receiving, from the vehicle, an end-pose and a reversing path for the vehicle;
calculating a reverse maneuver for the vehicle to move in reverse gear based on the end-pose and the reversing path;
transmitting, to the vehicle, signals to move the vehicle in reverse gear, the signals being transmitted at a signal rate above a predetermined rate threshold; and
stopping the vehicle in response to reaching the end-pose.

2. The computer-implemented system of claim 1, further comprising:
calculating a forward path of the vehicle moving in drive gear based on a pose of the vehicle during the reverse maneuver; and
providing instructions to shift the gear of the vehicle from reverse to drive.

3. The computer-implemented system of claim 1, wherein:
determining that a button on a user-interface is held in a selected state;
continuing transmitting signals to the vehicle in response to the button being held in the selected state;
determining that the button on the user-interface is released from the selected state; and
stopping transmitting signals to the vehicle in response to the button being released from the selected state such that the vehicle comes to a halt without shifting gear.

4. The computer-implemented system of claim 1, wherein the instructions to shift the gear of the vehicle from drive to reverse triggers a workflow comprising:
requesting, by a remote assistance platform, the vehicle to prepare for the reverse maneuver;
listening, by a reverse planner, for instructions to execute the reverse maneuver;
checking, by the reverse planner, for conditions that stop execution of the reverse maneuver;
transitioning the reverse planner to a pre-reverse state;
generating, by the remote assistance platform, the instructions to execute the reverse maneuver;
transitioning the reverse planner to a reverse state;
monitoring, by the reverse planner, conditions to execute the reverse maneuver; and
executing, by the reverse planner, the instructions to execute the reverse maneuver.

5. The computer-implemented system of claim 4, wherein the conditions that stop execution of the reverse maneuver include:
receiving instructions alerting to a state comprising at least one of manual state, temporary fault, safe stop, and hard stop;
steering wheel angle is below a predetermined angle threshold;
vehicle speed is below a predetermined speed threshold; and
a predetermined time has elapsed without additional instructions since a last received instruction by the reverse planner.

6. The computer-implemented system of claim 4, wherein the conditions to execute the reverse maneuver comprise:
the vehicle has shifted the gear to reverse;
instructions to execute the reverse maneuver have been received by the reverse planner;
a predetermined first time has elapsed without additional instructions since the instructions to reverse were received by the reverse planner; and
a predetermined second time has not elapsed without additional instructions since the instructions to reverse were received by the reverse planner, the second time being longer than the first time.

7. The computer-implemented system of claim 4, wherein executing the instructions to execute the reverse maneuver comprises:
checking for collision against prediction intents during movement by the vehicle in reverse gear;
remaining in the reverse state unless at least one of the following conditions is met:
(i) the vehicle has traveled a predetermined target distance,
(ii) the reverse planner detects a collision in the reversing path, or
(iii) more than a predetermined time has elapsed since instructions shift the gear to reverse were provided; and
pausing the reverse maneuver when the reverse planner detects a collision, the pausing comprising halting the vehicle without shifting gear.

8. The computer-implemented system of claim 4, wherein the workflow further comprises:
transitioning the reverse planner to a stop reverse state in response to determining that the conditions to execute the reverse maneuver are not met,
monitoring, by the reverse planner, conditions to transition out of the stop reverse state, and
transitioning the reverse planner to a pre-drive state in response to determining that the conditions to transition out of the stop reverse state are met.

9. A method, comprising:
generating, by a computer-implemented system, instructions to initiate a workflow in response to a first button on a user-interface transitioning from an unselected state to a selected state, the workflow being configured to enable a vehicle to reverse from an initial pose to a target pose;
generating, by the computer-implemented system, a visual representation of a path of the vehicle from the first pose to the target pose;
monitoring, by the computer-implemented system, a state of a second button on the user-interface, wherein the workflow is terminated in response to the state of the second button changing from a selected state to an unselected state after a predetermined duration; and
generating, by the computer-implemented system, instructions to move the vehicle along the path by a distance as calculated according to a movement of a slider on the user-interface, the instructions to move the vehicle being generated as long as the second button is in the selected state.

10. The method of claim 9, further comprising pausing, by the computer-implemented system, generating instructions to move the vehicle in response to the second button being released from the selected state, wherein pausing does not include shifting a gear of the vehicle from reverse to drive.

11. The method of claim 9, further comprising:
pausing, by the computer-implemented system, the workflow in response to a system state machine transitioning from a remote reverse state to a temporary fault state, wherein the system state machine transitions to the temporary fault state in response to a fault being detected in the vehicle; and
resuming, by the computer-implemented system, the workflow in response to the system state machine transitioning from the temporary fault state to the reverse state.

12. The method of claim 9, further comprising:
stopping, by the computer-implemented system, the workflow in response to the system state machine transitioning to a safe stop state; and
shifting a gear in the vehicle from reverse to drive.

13. The method of claim 9, further comprising:
stopping, by the computer-implemented system, the workflow in response to the system state machine transitioning to a hard stop state; and
bringing, by the computer-implemented system, the vehicle to a complete halt.

14. The method of claim 9, further comprising pausing, by the computer-implemented system, the workflow for an indefinite period of time, until blockages behind the vehicle in the path are cleared.

15. The method of claim 14, wherein the blockages are sensed by cameras in a rear portion of the vehicle.

16. An electronic device, comprising:
a display;
one or more processors;
a memory; and
one or more programs, wherein the one or more programs are stored in the memory and configured to be executed by the one or more processors, the one or more programs including instructions for displaying a user interface,
wherein:
the user interface comprises:
a first region configured to show a location of a vehicle and surrounding features;
a second region configured to show one or more selectable options and one or more instructions;
a third region configured to show a view from a camera of the vehicle; and
a fourth region comprising a first selectable button and a second selectable button,
triggering a workflow configured to move the vehicle in reverse gear along a selected path in response to selecting the first selectable button,
maintaining execution of the workflow in response to holding the first selectable button in a selected state,
temporarily pausing the workflow in response to releasing the first selectable button, such that the vehicle stops moving in reverse gear along the selected path, and
terminating the workflow in response to selecting the second selectable button.

17. The electronic device of claim 16, holding the first selectable button in the selected state comprises pressing down on the first selectable button manually.

18. The electronic device of claim 16, wherein the first region is further configured to show a visualization of a reverse path and a forward path of the vehicle.

19. The electronic device of claim 16, wherein:
the first region is configured further to show a slider coupled to a visualization of the vehicle,
the slider is configured to be moved toward or away from the vehicle by discrete predetermined equidistant spans,
moving the slider by one of the discrete predetermined equidistant spans is configured to cause the vehicle to move by a predetermined amount along a selected path.

20. The electronic device of claim 16, wherein the first region includes representations of spaces around the vehicle relevant to safe movement of the vehicle along the selected path.
